(19) United States
(12) Patent Application Publication
(10) Pub. No.: US 2013/0275496 A1
(43) Pub. Date: Oct. 17, 2013

(54) Method, Apparatus And System For Rendering Web Page

(71) Applicant: Tencent Technology (Shenzhen) Company Limited, Shenzhen (CN)

(72) Inventors: Yu XU, Shenzhen (CN); Shudong RUAN, Shenzhen (CN); Weiyu TOU, Shenzhen (CN)

(73) Assignee: TENCENT TECHNOLOGY (SHENZHEN) COMPANY LIMITED, Shenzhen (CN)

(21) Appl. No.: 13/908,678

(22) Filed: Jun. 3, 2013

Related U.S. Application Data
(63) Continuation of application No. PCT/CN2011/083450, filed on Dec. 5, 2011.

(30) Foreign Application Priority Data
Dec. 3, 2010 (CN) 201010586281.5

(51) Int. Cl. H04L 29/08

(52) U.S. Cl. CPC H04L 29/0809
USPC 709/203

(57) ABSTRACT

A method, apparatus and system for rendering a web page. A webcore is included at a server side and a RenderServer is configured at a server side in advance. The RenderServer parses a received web page into a DOM tree and sends the received web page to the webcore. The webcore renders the web page to form a render tree. The RenderServer transforms data information corresponding to Render objects on the render tree into binary stream according to the DOM tree and sends the binary stream to the mobile terminal. The mobile terminal performs drawing operation for the binary stream to implement web page browsing.

### CROSS-REFERENCE TO RELATED APPLICATIONS

This application is a continuation of International Patent Application No. PCT/CN2011/083450, filed on Dec. 5, 2011. This application claims the benefit and priority of Chinese Application No. 201010586281.5, filed Dec. 3, 2010. The entire disclosures of each of the above applications are incorporated herein by reference.

### FIELD

The present disclosure relates to computer technologies and to a method, apparatus and system for rendering a web page.

### BACKGROUND

This section provides background information related to the present disclosure which is not necessarily prior art.

With the promotion of 3G technologies, as well as the reduction of prices of mobile phones and network costs, when accessing the Internet via the mobile phone, users prefer to directly access Internet websites, rather than accessing Wap web pages mainly including texts, so as to obtain richer contents. Currently, when the mobile phone accesses the Internet website directly, the Internet web page returns a web page label to a mobile phone browser. The mobile phone browser parses and renders the web page label, and draws and displays the web page.

However, compared with a PC, the mobile phone has less memory, lower CPU frequency, slower network transmission speed and a higher cost. If the web page label is parsed and rendered by the mobile phone browser, the following can occur.

1) Too much memory is taken up.

For the purpose of parsing the rendering of the web page label, the mobile phone browser needs to store a set of parsing rendering engine codes in the memory. In addition, when the mobile phone browser renders the web page label, information, e.g. object variables, needs to be stored in the memory, and thus too much memory of the mobile phone is used.

2) Execution speed is slow.

The procedure of rendering the web page relates to a large number of calculations. Since the CPU frequency of the mobile phone is much lower than that of the PC, the execution speed of rendering the web page is greatly reduced.

2) Network speed is slow.

Comparing the mobile phone with the PC, the transmission speed of the wireless network is slower, and as data of the web page on the Internet are usually large, it will take a much longer time to transmit the data to the mobile phone.

### SUMMARY

This section provides a general summary of the disclosure, and is not a comprehensive disclosure of its full scope or all of its features.

The embodiments of the present invention provide a method, apparatus and system for rendering a web page, so that the web page is rendered by a server side, and problems caused by the web page being rendered by a mobile phone browser are avoided.

The technical solutions provided by various embodiments include:

A method for rendering a web page includes:
sending, by the RenderServer, a web page accessed by a mobile terminal to a webcore, and the web page being rendered by the webcore to form a render tree; and
serializing, by the RenderServer, data corresponding to render objects on the render tree, and sending a data sequence to the mobile terminal; the received data sequence being used by the mobile terminal to perform drawing operation to implement web page browsing.

An apparatus and system for rendering a web page, the apparatus being configured at a server side, and the apparatus includes:
a processing unit, adapted to send a web page accessed by a mobile terminal to a webcore; the web page being rendered by the webcore render to form a render tree; and
a transforming unit, adapted to serialize data corresponding to render objects on the render tree, and send a data sequence to the mobile terminal; the received data sequence being used by the mobile terminal to perform drawing operation to implement web page browsing.

A system for rendering a web page includes a web page, comprising a webcore, a mobile terminal and an above-mentioned apparatus.

As can be seen from the above technical solutions, according to various embodiments, a RenderServer is configured at the server side. The RenderServer renders the web page and sends the rendering result to the mobile phone browser, and the mobile phone browser performs the drawing operation according to the rendering result. The technical problems caused by the web page being parsed and rendered by the mobile phone browser are avoided, and the pressure of the CPU, memory and network data flow is reduced for the mobile phone browser.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a basic flowchart illustrating various embodiments;

FIG. 2 is a detailed flowchart illustrating various embodiments;

FIG. 3 is a flowchart illustrating the block 210 according to various embodiments;

FIG. 4 is a schematic diagram illustrating a TLV encoding format;

FIG. 5 is a basic schematic diagram illustrating an apparatus according to various embodiments; and

FIG. 6 is a detailed schematic diagram illustrating an apparatus according to various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In various embodiments, a method for rendering a web page is performed by a server side, a rendering result is sent to a mobile phone browser, and the mobile phone browser performs a drawing operation according to the rendering result. When compared with conventional methods in which the web page is rendered by the mobile phone browser, the pressure of the CPU, memory and network data flow is reduced for the mobile phone browser.

In order to make the object, technical solution and merits of various embodiments clearer, various embodiments will be illustrated in detail hereinafter with reference to the accompanying drawings and specific examples.

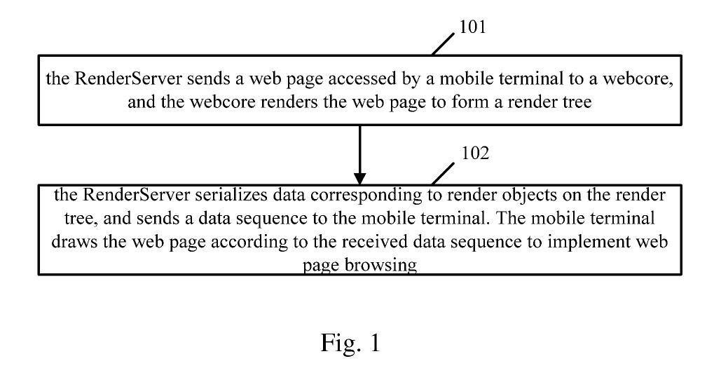

FIG. 1 is a basic flowchart illustrating various embodiments. Before the procedure is performed, a render server which is used to render web pages is configured at a server side in advance. In the following descriptions, the render server is also referred to as a RenderServer. Accordingly, as shown in FIG. 1, the procedure includes the following.

At 101, the RenderServer sends a web page accessed by a mobile terminal to a webcore, and the webcore renders the web page to form a render tree.

At 102, the RenderServer serializes data corresponding to render objects on the render tree, and sends a data sequence to the mobile terminal. The mobile terminal draws the web page according to the received data sequence to implement web page browsing.

In various embodiments, the server side instead of the mobile terminal, e.g. the mobile phone, performs the web page rendering operation, and sends the rendering result to the mobile terminal. The mobile terminal directly performs drawing operation according to the received binary stream, and thus the web page can be browsed fluently.

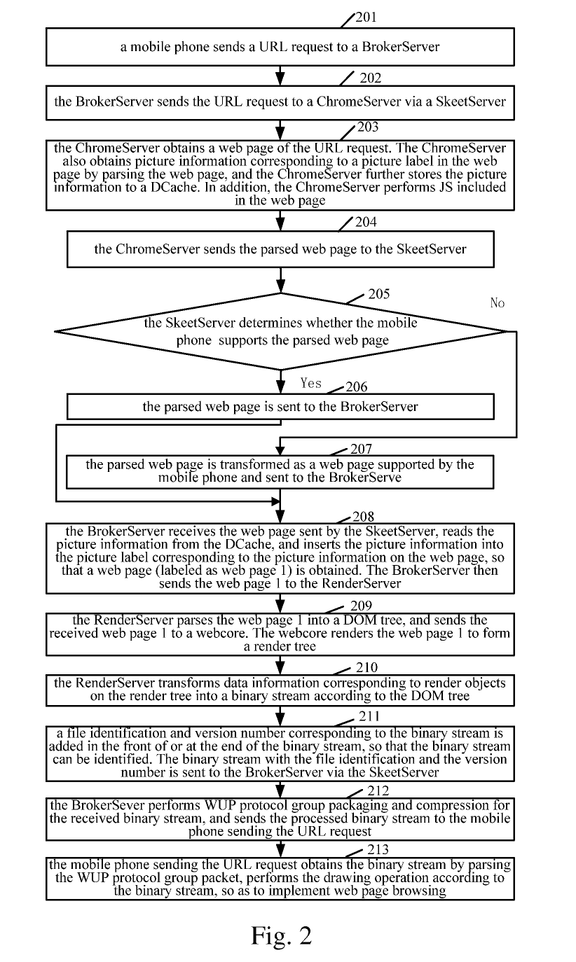

Various embodiments are mainly implemented via communications between the mobile terminal, e.g. the mobile phone and the server side, as shown in FIG. 2.

FIG. 2 is a detail flowchart illustrating various embodiments. As shown in FIG. 2, the procedure includes the following operations.

At 201, a mobile phone sends a Uniform Resource Locator (URL) request to a forwarding server. The forwarding server is also referred to as a BrokerServer in the following descriptions.

At 202, the BrokerServer sends the URL request to a ChromeServer via a server used to transform web pages. The server is referred as a SkeetServer in the following descriptions.

As can be seen, at 202, the BrokerServer and the SkeetServer sends the URL request to the ChromeServer.

At 203, the ChromeServer obtains a web page of the URL request. The ChromeServer also obtains picture information corresponding to a picture label in the web page by parsing the web page, and the ChromeServer further stores the picture information to a Data Cache (DCache). In addition, the ChromeServer performs JavaScript (JS) included in the web page.

At 204, the ChromeServer sends the parsed web page to the SkeetServer.

At 205, the SkeetServer determines whether the mobile phone sending the URL request supports the parsed web page to, i.e. display the parsed web page, if the mobile phone sending the URL request supports the parsed web page, 206 is performed. On the contrary, if the mobile phone sending the URL request does not support the parsed web page, 207 is performed.

At 206, the parsed web page is sent to the BrokerServer. Accordingly, 208 is performed.

At 207, the parsed web page is transformed as a web page supported by the mobile phone and sent to the BrokerServer.

Blocks 205-207 are performed mainly because most mobile phones only support wap2.0 web pages and do not support www web pages of Internet websites. In various embodiments, the SkeetServer is introduced to transform the www web page into wap2.0 page and send the wap2.0 page to the BrokerServer, when the mobile phone sending the URL request does not support www web page. In alternative embodiments, if the mobile phone sending the URL request has powerful functions and supports both wap2.0 web page and www web page, when receiving the www web page, the SkeetServer does not need to perform the transforming operation, but directly sends the www web page to the BrokerServer. As can be seen, 205 to 207 are selectively performed based on the functions of the mobile phones.

At 208, the BrokerServer receives the web page sent by the SkeetServer, reads the picture information from the DCache, and inserts the picture information into the picture label corresponding to the picture information on the web page, so that a web page (labeled as web page 1) is obtained. The BrokerServer then sends the web page 1 to the RenderServer.

At 209, the RenderServer parses the web page 1 into a Document Object Mode (DOM) tree, and sends the received web page 1 to a webcore. The webcore renders the web page 1 to form a render tree.

At 209, the RenderServer may parse the received web page into the DOM tree according to conventional parsing methods. The webcore may render the web page to form the render tree according to the conventional rendering methods.

At 210, the RenderServer transforms data information corresponding to render objects on the render tree into a binary stream according to the DOM tree.

Detailed operations at 210 may be referred to the procedure shown in FIG. 3.

FIG. 3 is a flowchart illustrating 210 according to various embodiments. As shown in FIG. 3, the procedure includes the following.

At 301, Render objects needed by the mobile phone sending the URL request are obtained from the render tree.

In various embodiments, the render objects needed by the mobile phone at least include: a RenderText object, a Renderlmage object, a control Render object, and Render objects associated with logic of the mobile phone sending the URL request; or all of the Render objects on the render tree.

The Render objects associated with the logic of the mobile phone at least include: a RenderView object (used to store document layout size, HTML Head label element, etc.), a RenderBlock object (Form table element) and etc.

Because the Render objects needed by the mobile phone are obtained, some unnecessary Render objects are filtered, so that data flow are saved when the Render objects are sent lately.

At 302, for each obtained Render object, rendering information of the Render object is obtained, DOM elements corresponding to the Render object and attributes of the DOM elements are obtained from the DOM tree.

Generally, the Render object corresponds to at least one DOM element.

The rendering information of the Render object is mainly mode information used when the drawing operation is performed by the mobile phone at 213, and includes at least: coordinates of the Render object on the screen, length, width, and color etc.

Detailed definitions of the DOM elements and the attributes of the DOM elements are similar to conventional definitions, which will not be described herein.

In various embodiments, the rendering information of the Render object is obtained. In addition, DOM elements corresponding to the Render object and attributes of the DOM elements are also obtained, so that the drawing operation at 213 can be performed. For example, the rendering information of the Render object includes the coordinates of the Render object on the screen, length, width, and color of the Render object. The label of the DOM element is <A> label, and the attribute is href=http://www.qq.com. When the mobile phone obtains the rendering information, the DOM element and the attribute of the DOM element, the drawing operation can be performed according to information, e.g. the locations, color and texts. In addition, an operation can be performed when the element is executed (e.g. clicked) based on the label attribute is <a>. Furthermore, a web page jumps to a corresponding web page based on the attribute (e.g. href=http://www.qq.com).

At 303, the obtained rendering information, the DOM element and the attribute of the DOM element are binary encoded respectively, such that a binary stream is obtained.

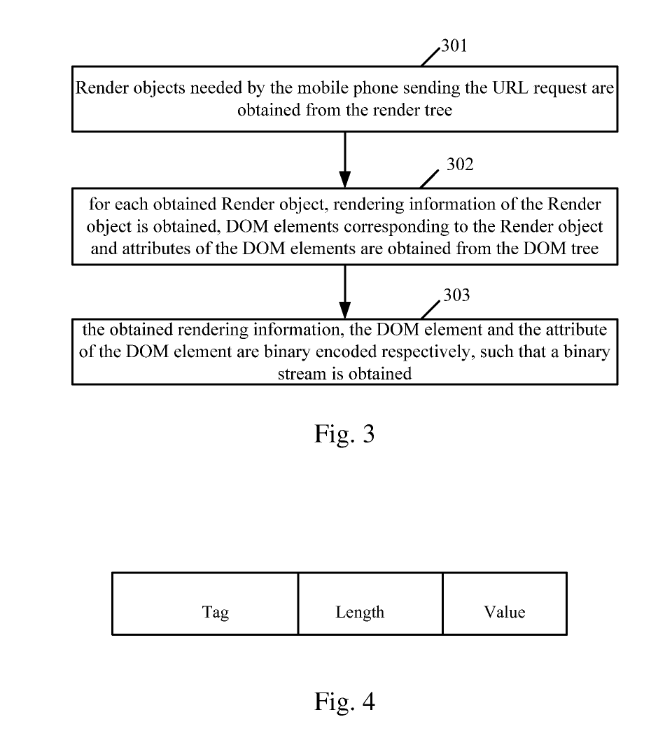

At 303, the obtained rendering information, the DOM element and the attribute of the DOM element are binary encoded respectively according to an encoding format of Tag-Length-Value (TLV) as shown in FIG. 4. In FIG. 4, the Tag field indicates a variable with certain length. The Tag uses 1 to 2 bytes. If the value of the information to be encoded (e.g. the rendering information, the DOM element and the attribute of the DOM element) is 0 to 254, a single byte is used. If the value of the information to be encoded is equal to or more than 255, the first byte is 0×FF, and the second byte is a value obtained by subtracting 255 from the value of the information to be encoded. The Length field indicates the length of the binary stream carried by the Value field. The Value field carries the binary stream and the length of the binary stream is determined according to the Length field. The binary stream may be numbers or strings. By using binary encoding, pressure of data transmission between the server side and the mobile phone is greatly reduced.

Thus, the procedure shown in FIG. 3 is finished.

In step 211, a file identification and version number corresponding to the binary stream is added in the front of or at the end of the binary stream, so that the binary stream can be identified. The binary stream with the file identification and the version number is sent to the BrokerServer via the SkeetServer.

Each of the file identification and the version number occupies one field, for example, 0×54, 0×51, 0×42, 0×4C, 0×00 and 0×01 etc.

At 212, the BrokerSever performs Wireless Uni-Protocol (WUP) protocol group packaging and compression for the received binary stream, and sends the processed binary stream to the mobile phone sending the URL request.

At 213, the mobile phone sending the URL request obtains the binary stream by parsing the WUP protocol group packet, and performs the drawing operation according to the binary stream, so as to implement web page browsing.

The drawing operation at 213 is similar to the conventional operation and will not be described herein.

Thus, the procedure shown in FIG. 2 is finished. As can be seen from the procedure shown in FIG. 2, according to various embodiments, the mobile phone only performs the drawing operation and does not perform the rendering operation, thereby avoiding problems caused by the rendering operation performed by the mobile phone browser, and the pressure of the CPU, memory and network data flow is reduced for the mobile phone browser.

The methods provided by various embodiment are described. An apparatus and a system will be described.

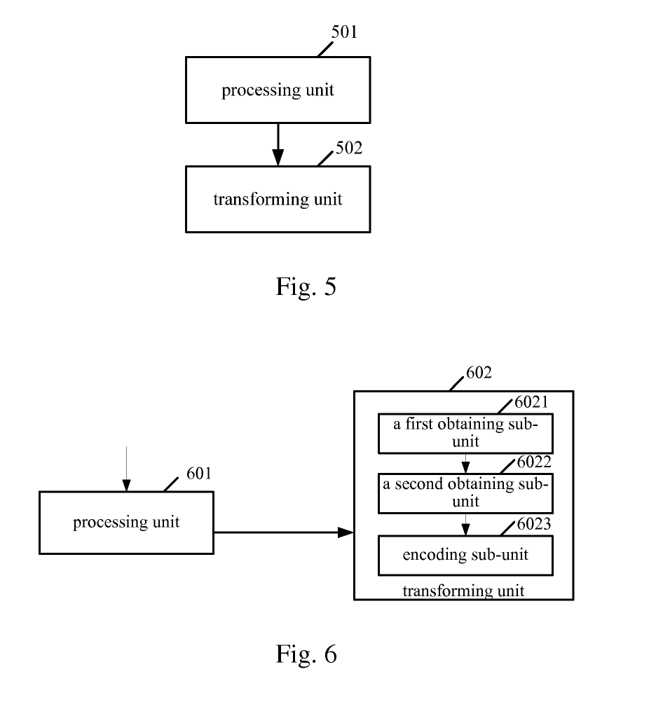

FIG. 5 is a basic schematic diagram illustrating an apparatus according to various embodiments. As shown in FIG. 5, the apparatus includes processing unit 501 and a transforming unit 502.

Processing unit 501 is adapted to send a web page accessed by a mobile terminal to a webcore. The webcore renders the web page to form a render tree.

Transforming unit 502 is adapted to serialize data corresponding to render objects on the render tree, and send a data sequence to the mobile terminal. The mobile terminal performs drawing operation according to the received data sequence to implement the web page browsing.

The apparatus provided by various embodiments is described briefly as above, and detailed descriptions will be provided as follows.

FIG. 6 is a detailed schematic diagram illustrating an apparatus according to various embodiments. As shown in FIG. 6, the apparatus includes processing unit 601 and transforming unit 602. The functions of processing unit 601 and transforming unit 602 are similar to that of processing unit 501 and transforming unit 502 respectively, and will not be further described herein.

Preferably, processing unit 601 is further adapted to parse the web page accessed by the mobile terminal into a DOM tree. Accordingly, as shown in FIG. 6, transforming unit 602 includes first obtaining sub-unit 6021, second obtaining sub-unit 6022 and encoding sub-unit 6023.

First obtaining sub-unit 6021 is adapted to obtain Render objects needed by the mobile phone from the render tree. In various embodiments, the render objects needed by the mobile phone at least include: a RenderText object, a Renderlmage object, at least one control Render object, and Render objects associated with logic of the mobile phone; or all of the Render objects on the render tree.

Second obtaining sub-unit 6022 is adapted to, for each obtained Render object, obtain rendering information of the Render object, obtain a DOM element corresponding to the Render object and attributes of the DOM element from the DOM tree.

Encoding sub-unit 6023 is adapted to binary encode the obtained rendering information, the DOM element and the attribute of the DOM element respectively, and obtain a binary stream.

Various embodiments also provide a system for rendering a web page by a server side. The system includes a webcore, a mobile terminal, e.g. a mobile phone and an apparatus shown in FIG. 5 or 6.

In various embodiments, the system also includes: a ChromeServer, a DCache and a BrokerServer.

The ChromeServer obtains an original web page of a URL request sent by the mobile terminal, obtains picture information corresponding to a picture label in the original web page by parsing the original web page, stores the picture information to a DCache, performs JS included in the original web page, and sends the parsed web page to the BrokerServer.

The BrokerServer reads the picture information from the DCache after receiving the parsed web page, inserts the picture information into the picture label corresponding to the picture information on the web page, obtains a web page, and sends the web page to the processing unit of the apparatus.

Preferably, the server side also includes a SkeetServer located between the ChromeServer and the BrokerServer.

The SkeetServer determines whether the mobile phone supports the parsed web page after receiving the web page sent by the ChromeServer. If the mobile phone does not support the parsed web page, the SkeetServer transforms the parsed web page as a web page supported by the mobile terminal and sends the web page supported by the mobile terminal to the BrokerServer. If the mobile phone supports the parsed web page, the SkeetServer sends the parsed web page to the BrokerServer.

Preferably, the apparatus sends the binary stream to the BrokerServer via the SkeetServer. The BrokerServer then performs WUP protocol group packaging and compression for the received binary stream, and the BrokerServer further sends the processed binary stream to the mobile terminal.

The mobile terminal obtains the binary stream by parsing the WUP protocol group package and performs drawing operation for the web page according to the binary stream.

As can be seen from the above technical solutions, in various embodiments, the RenderServer is added at the server side, and the RenderServer renders the web page and sends the rendering result to the mobile terminal, e.g. the mobile phone browser, and the mobile browser performs the drawing operation according to the rendering result, thereby avoiding problems caused by the rendering operation performed by the mobile phone browser, and the pressure of the CPU, memory and network data flow is reduced for the mobile phone browser.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for rendering a web page, a RenderServer being configured at a server side in advance, and the method comprising:
sending, by the RenderServer, a web page accessed by a mobile terminal to a webcore, and the web page being rendered by the webcore to form a render tree; and
serializing, by the RenderServer, data corresponding to render objects on the render tree, and sending a data sequence to the mobile terminal; the received data sequence being used by the mobile terminal to perform drawing operation to implement web page browsing.

2. The method of claim 1, wherein sending, by the RenderServer, a web page accessed by a mobile terminal to a webcore comprises:
parsing, by the RenderServer, the web page accessed by the mobile terminal into a Document Object Mode (DOM) tree;
serializing, by the RenderServer, data corresponding to render objects on the render tree comprises:
obtaining Render objects needed by the mobile phone from the render tree;
for each obtained Render object, obtaining rendering information of the Render object, obtaining a DOM element corresponding to the Render object and attributes of the DOM element from the DOM tree;
binary encoding the obtained rendering information, the DOM element and the attribute of the DOM element respectively, and obtaining a binary stream.

3. The method of claim 2, wherein the render objects needed by the mobile phone at least comprises: a RenderText object, a Renderlmage object, a control Render object, and Render objects associated with logic of the mobile phone; or all of the Render objects on the render tree.

4. The method of claim 2, wherein the binary encoding is performed according to a TLV encoding format; and
the method further comprises: adding a file identification and version number corresponding to the binary stream in the front of or at the end of the binary stream, to identify the binary stream.

5. The method of claim 2, wherein the server side further comprises: a ChromeServer, a Data Cache (DCache) and a BrokerServer; and the method further comprises:
obtaining, by the ChromeServer, a web page of a URL request sent by the mobile terminal, obtaining picture information corresponding to a picture label in the web page by parsing the web page, storing the picture information to the DCache, performing JavaScript (JS) included in the web page, and sending the parsed web page to the BrokerServer;
reading, by the BrokerServer, the picture information from the DCache after receiving the web page, inserting the picture information into the picture label corresponding to the picture information on the web page, obtaining a web page, and sending the web page to the RenderServer.

6. The method of claim 5, wherein the server side further comprises a SkeetServer located between the ChromeServer and the BrokerServer;
sending, by the ChromeServer, the parsed web page to the BrokerServer comprises:
sending, by the ChromeServer, the parsed web page to the SkeetServer;
determining, by the SkeetServer, whether the mobile phone supports the parsed web page after receiving the parsed web page, if the mobile phone does not support the parsed web page, transforming the parsed web page as a web page supported by the mobile terminal and sending the web page supported by the mobile terminal to the BrokerServer; if the mobile phone supports the parsed web page, sending the parsed web page to the BrokerServer.

7. The method of claim 6, wherein sending, by the RenderSever, a data sequence to the mobile terminal comprises:
sending, by the RenderSever, the binary stream to the BrokerServer via the SkeetServer; and performing, by the BrokerServer, WUP protocol group packaging and compression for the received binary stream, and sending the processed binary stream to the mobile terminal; and
the mobile terminal obtains the binary stream by parsing the WUP protocol group package and performs the drawing operation according to the binary stream.

8. An apparatus for rendering a web page, the apparatus being configured at a server side, and comprising:
a processing unit, adapted to send a web page accessed by a mobile terminal to a webcore; the web page being rendered by the webcore render to form a render tree; and
a transforming unit, adapted to serialize data corresponding to render objects on the render tree, and send a data sequence to the mobile terminal; the received data sequence being used by the mobile terminal to perform drawing operation to implement web page browsing.

9. The apparatus of claim 8, wherein the processing unit is further adapted to parse the web page accessed by the mobile terminal into a DOM tree; and
the transforming unit comprises:
a first obtaining sub-unit, adapted to obtain Render objects needed by the mobile phone from the render tree;
a second obtaining sub-unit, adapted to, for each obtained Render object, obtain rendering information of the Render object, obtain a DOM element corresponding to the Render object and attributes of the DOM element from the DOM tree;
an encoding sub-unit, adapted to binary encode the obtained rendering information, the DOM element and the attribute of the DOM element respectively, and obtain a binary stream.

10. The apparatus of claim 8, wherein the render objects needed by the mobile phone at least comprises: a RenderText object, a Renderlmage object, a control Render object, and Render objects associated with logic of the mobile phone; or all of the Render objects on the render tree.

11. A system for rendering a web page, comprising a webcore, a mobile terminal and an apparatus claimed in claim 8.

12. The system of claim 11, further comprising: a ChromeServer, a DCache and a BrokerServer; wherein
the ChromeServer is adapted to obtain an original web page of a URL request sent by the mobile terminal, obtain picture information corresponding to a picture label in the original web page by parsing the original web page, store the picture information to a DCache, perform JS included in the original web page, and send the parsed web page to the BrokerServer;
the BrokerServer is adapted to read the picture information from the DCache after receiving the parsed web page, insert the picture information into the picture label corresponding to the picture information on the web page, obtain a web page, and send the web page to the processing unit of the apparatus.

13. The system of claim 12, further comprising a SkeetServer located between the ChromeServer and the BrokerServer; wherein
the SkeetServer is adapted to determine whether the mobile phone supports the parsed web page after receiving the parsed web page sent by the ChromeServer, if the mobile phone does not support the parsed web page, transform the parsed web page as a web page supported by the mobile terminal and send the web page supported by the mobile terminal to the BrokerServer; if the mobile phone supports the parsed web page, send the parsed web page to the BrokerServer.

14. The system of claim 13, wherein the apparatus is adapted to send the binary stream to the BrokerServer via the SkeetServer, and the BrokerServer is adapted to perform WUP protocol group packaging and compression for the received binary stream, and send the processed binary stream to the mobile terminal;
the mobile terminal is adapted to obtain the binary stream by parsing the WUP protocol group package and perform drawing operation for the web page according to the binary stream.
